(19) United States
(12) Patent Application Publication
(10) Pub. No.: US 2011/0195008 A1
(43) Pub. Date: Aug. 11, 2011

(54) DESULFURIZATION PROCESS

(75) Inventors: Johannes Menzel, Waltrop (DE); Olaf Von Morstein, Essen (DE)

(73) Assignee: UHDE GMBH, Dortmund (DE)

(21) Appl. No.: 12/998,288

(22) PCT Filed: Oct. 5, 2009
(86) PCT No.: PCT/EP2009/007119

§ 371 Date: Apr. 14, 2011

(30) Foreign Application Priority Data
Oct. 6, 2008 (DE) 10 2008 050 088.7

(51) Int. Cl. B01D 53/48

(52) U.S. Cl. 423/242.1

(57) ABSTRACT

The invention relates to a desulfurization process, wherein a gas mixture is subjected to a separation process to separate the acidic components of the gas, an acid gas containing carbon dioxide and sulfur compounds, in particular hydrogen sulfide, being formed in this process, the acid gas being sent to a Claus plant for separation of elemental sulfur, and the residual gas leaving the Claus plant being subjected to a further separation, in which the water formed in the Claus process is at least partially removed, only technically pure oxygen being supplied as the oxygen-containing reaction gas to the Claus plant, and carbon dioxide in a purity which allows direct sequestration or industrial utilization being removed downstream from the Claus plant.

The invention relates to a desulfurization process, wherein a gas mixture is subjected to a separation process to separate acid components of the gas, thereby forming an acid gas that contains carbon dioxide and sulfur compounds, in particular hydrogen sulfide. In this process, acid components of the gas are first removed from the gas stream with a suitable absorbent and are thus separated from the useful gas component. In regeneration of the absorbent, which is carried in circulation, the acid gas components contained in it are released and then sent to a Claus plant.

The Claus process is usually performed by incinerating the acid gas in air, wherein the hydrogen sulfide (H₂S) is reacted with the oxygen (O₂) present in the combustion air to form elemental sulfur and water (H₂O), and the elemental sulfur (S) is separated by downstream cooling in condensers (Ullmann's Encyclopedia of Industrial Chemistry, volume 10, edition 4, 1975, page 594). With the known Claus process, a yield of up to 98% can usually be achieved. To achieve additional purification of the residual gas, it may be subjected to a residual gas purification process. The elemental sulfur formed in the Claus process can be extracted and utilized commercially, but the purified residual gas is usually discharged to the environment without being used.

As a so-called greenhouse gas, carbon dioxide contributes to the global greenhouse effect, so there is a need to prevent the additional release of carbon dioxide. At the present, there are also known processes requiring large amounts of carbon dioxide as a process gas. For example, carbon dioxide can be used to increase yield in oil recovery, in which carbon dioxide is injected into an oil reservoir (enhanced oil recovery, EOR). For sequestering of carbon dioxide to reduce emissions and for industrial utilization, carbon dioxide must be removed from the other components, e.g., nitrogen, usually at a considerable expense.

The document EP 0 059 412 A2 relates to a process for regulating the amount of ballast gas in a combustion process, in particular in operation of a Claus system, in which the residual gas formed is discharged to the environment in the usual manner. To achieve optimum combustion, air and technically pure oxygen are to be supplied, with the ratio of air and technically pure oxygen being adapted to the respective amount of inert gas in the combustion gas. The term “technically pure oxygen” refers to a gas consisting largely of oxygen and formed in a recovery process, usually performed industrially on a large scale. The purity is usually greater than 90%, and the purity in cryogenic decomposition processes is typically at least 98%.

It is also known from the article by H. Fischer in Chemie-Ing.-Techn., vol. 39, 1967, pages 515-520, that for the conversion of the acid gas to achieve a sufficiently high combustion temperature, technically pure oxygen is to be supplied to a Claus system when the amount of hydrogen sulfide is between 20 vol % and approx. 5 vol %. The residual gas is also released as an exhaust gas in the usual manner.

The object of the invention is to make available a process having the features described in the introduction to allow the use of carbon dioxide contained in the acid gas at a low cost.

This object is achieved according to the invention by a process according to patent claim 1. According to the present invention, the sulfur component fraction and the carbon dioxide fraction present in the acid gas should be extracted separately in the purest possible form. With the processes known from the prior art, mostly pure separation is possible only at a very high cost because known absorption processes cannot separate sulfur components on the one hand and carbon dioxide on the other hand from a gas mixture with a high selectivity. However, it is comparatively simple to implement combined separation of carbon dioxide and sulfur components in a combined acid gas fraction, which is sent to a Claus plant for further processing and then is converted inexpensively to elemental sulfur and carbon dioxide within the scope of the inventive process. For combined separation of carbon dioxide and sulfur components, scrubbing methods that act chemically and physically, for example, may be used. According to the invention, the Claus plant receives only technically pure oxygen as the oxygen-containing reaction gas. Therefore, in an especially advantageous manner, this achieves the result that when processing the acid gas, no inert gas components that would have to be separated subsequently from the carbon dioxide at great expense are added.

Within the scope of a preferred embodiment of the inventive process, it is provided that, when a maximum allowed combustion temperature is exceeded within the combustion chamber of the Claus plant, a portion of the residual gas from the process is removed at the downstream end of the Claus plant and sent together with the technically pure oxygen to the combustion chamber for cooling. Through the measures described here, accurate control of the combustion process is possible without interfering with the carbon dioxide concentration effect.

In the case of an acid gas consisting essentially of carbon dioxide and sulfur components, especially H₂S, COS and mercaptans, almost complete separation can thus be achieved. The water and the elemental sulfur generated by the reaction of sulfur components with oxygen in the Claus process are condensed out of the residual gas, so the carbon dioxide concentration is greatly increased. To remove at least most of any residues of sulfur compounds that might remain, the residual gas leaving the Claus plant may be subjected to a downstream gas purification process. For example, hydrogenation may be performed, in which the sulfur components present in addition to H₂S in the residual gas are hydrogenated to H₂S. The residual gas is then quenched and a selective scrubbing is performed, preferably with a chemical absorbent, removing most of the H₂S still present in the residual gas. After the additional removal of sulfur components, the residual gas consists essentially of carbon dioxide, water and small amounts of carbon monoxide and hydrogen. For example, the SCOT® process (Shell Claus Off-gas Treatment) is a suitable residual gas purification process.

To convert some of the hydrogen and/or carbon monoxide to water and/or carbon dioxide, after-burning of residual gas with technically pure oxygen may be performed, preferably in a catalytic process. If the acid gas originally supplied to the Claus plant consists essentially of sulfur compounds and carbon dioxide, then the residual gas after performing a residual gas purification process and after-burning to remove hydrogen and/or carbon monoxide contains only almost pure carbon dioxide and water vapor, which is condensed out in further treatment of the residual gas. Furthermore, known methods for drying the gas may also be used to further reduce the water content. The residual gas consisting essentially of carbon dioxide after removal of water is for sequestration, i.e. in particular for storage in geological formations such as deposits of oil, natural gas deposits, aquifiers, coal seams or in the deep see, or for technical use usually compressed or liquefied, whereby in particular a temporary storage or transport of carbon dioxide may be provided. Depending on the additional use of carbon dioxide that has been provided, the purity in the gaseous state expediently amounts to 80 vol %, preferably 90 vol %, especially preferably 95 vol %.

In addition or as an alternative to after-burning of hydrogen and/or carbon monoxide with technically pure oxygen, the components listed above can also be removed by changes in pressure and/or temperature of the residual gas. For example, it is possible to provide for the residual gas to be freed of most of the water vapor by means of a gas condenser and a quenching column after a residual gas purification process has been performed and then to compress the carbon dioxide to liquefy it. Carbon monoxide and hydrogen may then be removed from the liquefied carbon dioxide in a suitable separation device.

If the acid gas supplied to the Claus plant also contains, in addition to carbon dioxide and sulfur components, inert gas components, then at least the cost of a downstream separation can be minimized because with the inventive desulfurization process, no additional inert gas components are supplied.

In an especially advantageous manner, the use of technically pure oxygen as provided according to the present invention also allows smaller dimensions of the Claus plant for a given quantity of acid gas and of a device for residual gas purification which is optionally provided, so that the additional expense necessary to provide technically pure oxygen can be compensated.

The subject of the invention is also a device for performing the process according to claim 11. In addition to the usual components, the device includes in particular a connecting line, which connects an inlet of the combustion chamber of the Claus plant to a gas conduit downstream from the Claus plant or a storage container for the residual gas downstream from the Claus plant. In addition, a control unit is provided on the connecting line for on-demand control of the admixture of the residual gas inherent in to the process at the inlet.

1-11. (canceled)

12. A desulfurization process, whereby a gas mixture is subjected to a separation process to separate the acidic components of the gas, in which an acid gas containing carbon dioxide and sulfur compounds, in particular hydrogen sulfide, is formed, whereby the acid gas is sent to a Claus plant for separation of elemental sulfur, only technically pure oxygen is supplied as the oxygen-containing reaction gas and whereby carbon dioxide in a purity which allows direct sequestration or industrial utilization is removed downstream from the Claus plant, wherein the residual gas is subjected to after-burning to remove hydrogen and carbon monoxide with technically pure oxygen and wherein water vapor is condensed out from the residual gas.

13. The process according to claim 12, wherein a catalytic after burning process of the residual gas is carried out.

14. The process according to claim 12, wherein an admixture of a portion of the residual gas inherent in the process, said portion being taken downstream from the Claus plant, is supplied to the Claus plant when the maximum allowed combustion temperature is exceeded in a combustion chamber of the Claus plant.

15. The process according to claim 12, wherein all the acid gas components are removed jointly from the gas mixture in the separation process and are extracted as acid gas in a combined fraction.

16. The process according to claim 12, wherein the separation process comprises scrubbing the gas mixture with a physical and/or chemical absorbent and regenerating the absorbent.

17. The process according to claim 12, wherein the residual gas leaving the Claus plant is subjected to a residual gas purification process, in particular the SCOT® process, to at least most of the residues of sulfur compounds.

18. The process according to claim 12, wherein the residual gas is compressed for further utilization.
